(19) United States
(12) Patent Application Publication
(10) Pub. No.: US 2012/0174553 A1
(43) Pub. Date: Jul. 12, 2012

(54) Header with Elevated Doors for Tall Robust Crops

(75) Inventors: Martin E. Pruitt, Hesston, KS (US); Stanley R. Clark, Hesston, KS (US)

(73) Assignee: AGCO Corporation, Duluth, GA (US)

(21) Appl. No.: 13/348,691

(22) Filed: Jan. 12, 2012

Related U.S. Application Data
(60) Provisional application No. 61/431,989, filed on Jan. 12, 2011.

(51) Int. Cl. A01D 43/00

(52) U.S. Cl. 56/158

(57) ABSTRACT

A header assembly supported on the front of a windrower includes a header configured to process crop material standing in a field and a lean bar as the leading element for contacting crop material and preparing the crop material for processing by the header. The lean bar is positioned forward of the header so that the lean bar is the forward-most element of the header assembly. The header assembly has a plurality of cutting elements arranged in a line transverse the header. A cutter bar shield door is positioned to an elevated position such that a forward most point of the cutter bar shield door is above a rearward most point of the cutter bar shield door. The forward most point of the cutter bar shield door lies on or behind a line drawn between the forward edge of the lean bar and a rotational center of the cutting elements.

### CROSS REFERENCE TO RELATED APPLICATIONS

This application claims priority to U.S. Provisional Application No. 61/431,989 filed Jan. 12, 2011, entitled “HEADER WITH ELEVATED DOORS FOR TALL ROBUST CROPS”.

### BACKGROUND OF THE INVENTION

1. Field of Invention

This invention relates generally to crop harvesting equipment, and more particularly to a mower/conditioner having cutter bar door structure for directing tall robust crop material into the proper orientation for feeding and cutoff.

2. Description of Related Art

Lean bars, also known as knock-down bars, may be used to knock down crop material for cutoff and feeding into a header. For example, lean bars may be used to knock down the top end of high biomass crop material for proper feeding into a header which cuts and conditions the crop material and deposits conditioned crop material into a swath or windrow. However, with tall robust crops, the cut crop has a tendency to be pinched between the standing crop and lower surfaces of the cutter bar doors, thereby restricting flow into the conditioner rolls. It would be desirable to have a cutter bar door structure for directing tall robust crop material into the proper orientation for feeding and cutoff.

### BRIEF DESCRIPTION OF THE DRAWINGS

The above mentioned and other features of this invention will become more apparent and the invention itself will be better understood by reference to the following description of embodiments of the invention taken in conjunction with the accompanying drawings, wherein:

FIG. 1 shows a perspective view of an example embodiment of a self-propelled windrower that may employ a header arrangement in accordance with the present invention;

FIG. 2 shows a perspective view of an example embodiment of a header assembly;

FIG. 3 shows another perspective view of the header assembly of FIG. 1; and

FIG. 4 shows a side cutaway view of the header arrangement of FIG. 2.

Corresponding reference characters indicate corresponding parts throughout the views of the drawings.

### OVERVIEW OF THE INVENTION

In an example embodiment, a header assembly supported on the front of a windrower operable to process crop material standing in a field. The header assembly includes a header configured to process crop material and lean bar as the leading element for contacting crop material and preparing the crop material for processing by the header. The header assembly has a plurality of cutting elements, said plurality of cutting elements arranged in a line transverse the header. A cutter bar shield door is positioned to an elevated position such that a forward most point of the cutter bar shield door is above a rearward most point of the cutter bar shield door. In one embodiment, a lean bar positioned a distance forward of the header so that the lean bar is the forward-most element of the header assembly. The forward most point of the cutter bar shield door lies on or behind a line drawn between the forward edge of the lean bar and a rotational center of the cutting elements.

In another example embodiment, the invention is directed to a method of processing crop material in a field using a header assembly supported on the front of a windrower having a plurality of cutting elements in a line transverse the header used to cut standing crop material in the field. The method includes mounting a lean bar a distance forward of the header so that the lean bar is the forward-most element of the header assembly and positioning a cutter bar shield door to an elevated position such that a forward most point of the cutter bar shield door is above a rearward most point of the cutter bar shield door and the forward most point of the cutter bar shield door lies on or behind a line drawn between the forward edge of the lean bar and a rotational center of the cutting elements. The header assembly is driven through the field such that the crop material is bent by the lean bar and severed by the cutting elements before the crop material is pinched between the standing crop and a lower surface of the cutter bar shield door.

### DESCRIPTION OF EXAMPLE EMBODIMENTS

As required, example embodiments of the present invention are disclosed. The various embodiments are meant to be non-limiting examples of various ways of implementing the invention and it will be understood that the invention may be embodied in alternative forms. The present invention will be described more fully hereinafter with reference to the accompanying drawings in which like numerals represent like elements throughout the several figures, and in which exemplary embodiments are shown. The figures are not necessarily to scale and some features may be exaggerated or minimized to show details of particular elements, while related elements may have been eliminated to prevent obscuring novel aspects. The specific structural and functional details disclosed herein should not be interpreted as limiting, but merely as a basis for the claims and as a representative basis for teaching one skilled in the art to variously employ the present invention.

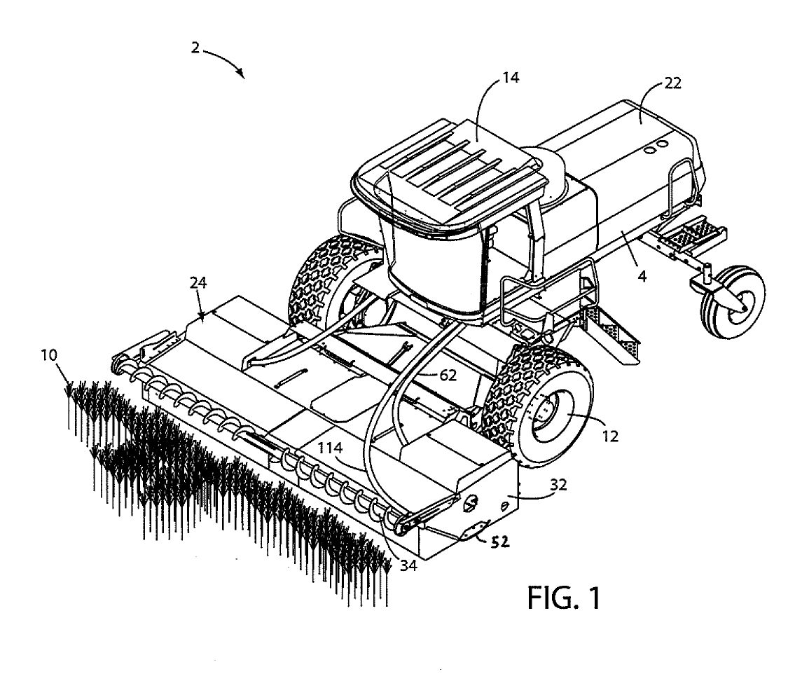

Turning now to the Figures, FIG. 1 shows a harvester in the form of a self-propelled windrower 2 operable to process crop material, such as knocking down, cutting and collecting standing crop 10 in the field, conditioning the cut material, and discharging the conditioned material in a windrow or swath. The windrower 2 may include a chassis or frame 4 supported by wheels 12 for movement across a field to be harvested. The frame 4 may carry a cab 14, within which an operator controls operation of the windrower 2, and a rearwardly spaced compartment 22 housing a power source (not shown) such as an internal combustion engine.

A harvesting header assembly 24 may be supported on the front of the frame 4 and include a header 32 and a lean bar 36 configured to knock down crop material 10. The lean bar 36 may be positioned a distance forward of the header 32 so that the lean bar 36 is the forward-most, or leading, element of the header assembly 24. The lean bar 36 is configured to knock down crop material for processing by the header 32. For example, the lean bar may engage the top end of crop material as the header assembly 24 moves through the field. The particular arrangement of the header 32 may be similar to that disclosed in US Patent No. 6,158,201 to Pruitt et al. entitled “Rotary Mower Conditioner Having Improved Crop Flow” and U.S. Pat. No. 7,726,108 entitled “Wide Cut Rotary Harvester Having Crop Feeding Mechanism” both of which are assigned to the assignee of the present invention.

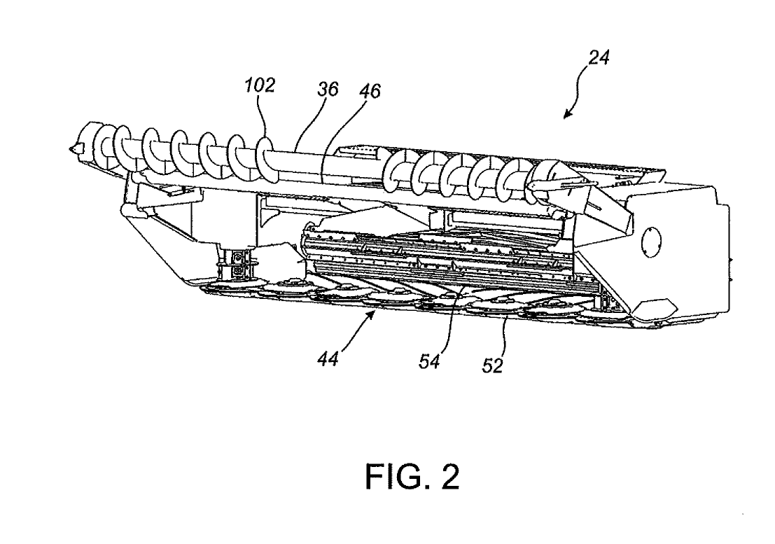

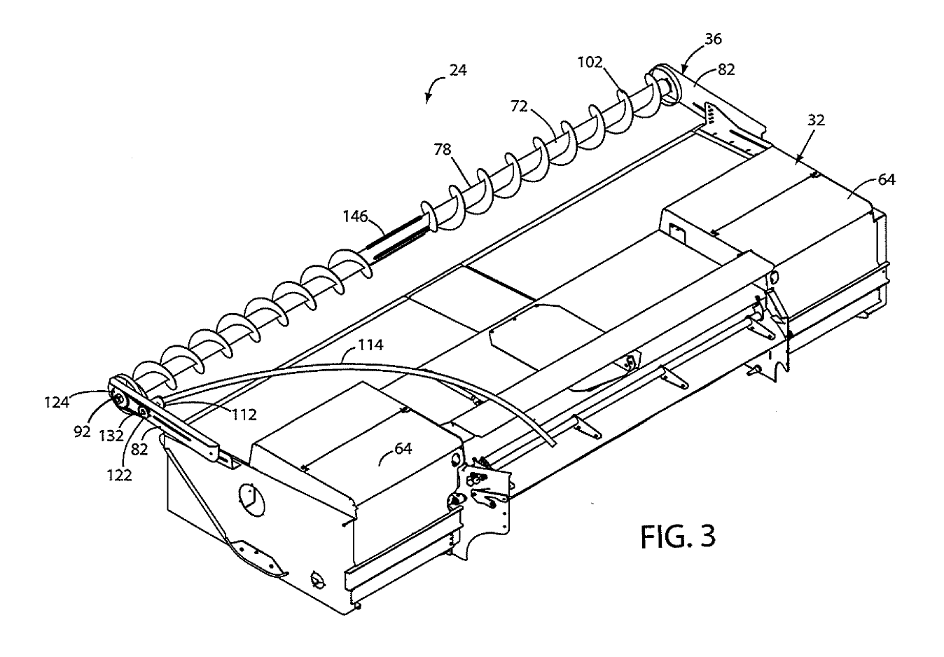

Turning now to FIGS. 2 and 3, the header 32 includes a cutting bed 44 with a plurality of cutting elements 52 located transversely across the header 32 for cutting crop material and conditioning rolls 54 for conditioning the cut material. Generally planer cutter bar shield doors 46 cover a front portion of the header. The header 32 may be powered by hydraulic lines 62 (FIG. 1) extending from the vehicle 10 to hydraulic motors (not shown) housed within motor housings 64. The motors may power the cutting elements 52 of the cutting bed 44 by a gear arrangement or other means. The conditioning rolls 54 may be laterally narrower than the cutoff width of the cutting bed 44 so that it may be desirable to urge crop material laterally inward for conditioning by the conditioning rolls.

As best seen in FIG. 3, the lean bar 36 may comprise a generally cylindrically-shaped transversely-extending member 72, shown in the example embodiment as a hollow tube. The outer surface 78 of the member 72 is configured to contact and knock down crop material 10. The member 72 may be coupled to the header 34 by a pair of adjustable positioning arms 82. As seen in the example embodiment, the positioning arms 82 are arranged such that the lean bar 36 is positioned as the leading element in the arrangement. The lean bar 36 may be rotatably mounted to the positioning arms 82. For example, shaft ends of the member 72 may be journaled for rotation at the positioning arms 82 by bearing assemblies 92. The rotation of the lean bar 36 assists in urging the crop material in a desired direction, such as rearward toward the header 32.

In the example embodiment shown in FIG. 2 the lean bar 36 may be mounted for free rotation as the leading element in the header assembly 24 so that as the header 32 moves through the field, the lean bar 36 contacts the crop material resulting in the rotation of the lean bar 36. Rotation assisting elements (not shown) may be provided at the lean bar 36 to further engage the crop material 10 and assist in lean bar rotation as is known in the art. For example, fingers, feeding bars, paddles, and the like, may extend radially from the transverse member 72 so as to engage crop material 10 passing under the lean bar 36 and more effectively rotate the lean bar 36 as the bar 34 pushes the crop material 10 downward. In one example embodiment, the fingers may have a length of about 3 inches and a diameter/width of about 0.5 inches.

The lean bar 36 may also be provided with crop urging elements 102 configured to urge crop material in a desired direction. In the example embodiment of FIG. 2, auger flights 102 are arranged at the outer lateral portion of the lean bar 36 so as to urge crop material laterally inward toward the conditioning rolls 54 of the header 32. This rotation of the lean bar 36, either by the contact of the lean bar with the crop material or otherwise driven, allows the auger flights 102 to assist in urging the crop material toward the conditioning rolls 54 of the header 26. In addition or in lieu of the auger flights 102, disks or other urging elements could be used. In the example embodiment shown in FIG. 3 the lean bar 36 also includes fluting 103 at the center of the lean bar between the auger flights 102 to urge crop material rearward toward the conditioning rolls 54. The fluting 103 is in the form of bars having a diameter of about 0.5 inches welded to the outer surface 18 of the lean bar 36.

The lean bar 36 and its associated crop urging elements may be arranged so as to provide crop material 10 to the header in a desired orientation for optimum feeding to the next element of the header 32, such as having the length of the crop material stalk perpendicular to the cutting bar, or parallel to the direction of header travel. The crop material provided to the header 32 may be processed by the header 32 and discharged through a rear opening 104 (FIG. 3) and guided by guide plates 106 into a windrow or swath.

Whereas in the example embodiments discussed above the lean bar 36 may be arranged for free rotation and rotated by contact with crop material, it is to be understood that the rotation of the lean bar 36 could be driven powered. For example, in the embodiment shown in FIG. 3, a hydraulic motor 112 may be mounted on a positioning arm 82 and powered by a hydraulic line 114 extending from the vehicle 2. The motor 112 may be driven by movement of fluid within the hydraulic line 114 by a pump or other fluid source as known to one of ordinary skill in the art. In the example embodiment shown, the motor 112 may be coupled to a first pulley 122 mounted on a positioning arm 82. The first pulley 122 may be coupled to a second pulley 124 by a drive belt 132 and the second pulley 124 coupled to a shaft 84 of the lean bar 36 journaled in the bearing assembly 92. Through this arrangement, operation of the motor 112 results in the rotation of the lean bar 36. While in the example embodiments a hydraulic motor 112 is used to power the rotation of the lean bar 36, other means could be used, such as an electric drive or a mechanical arrangement coupled to the lean bar 36.

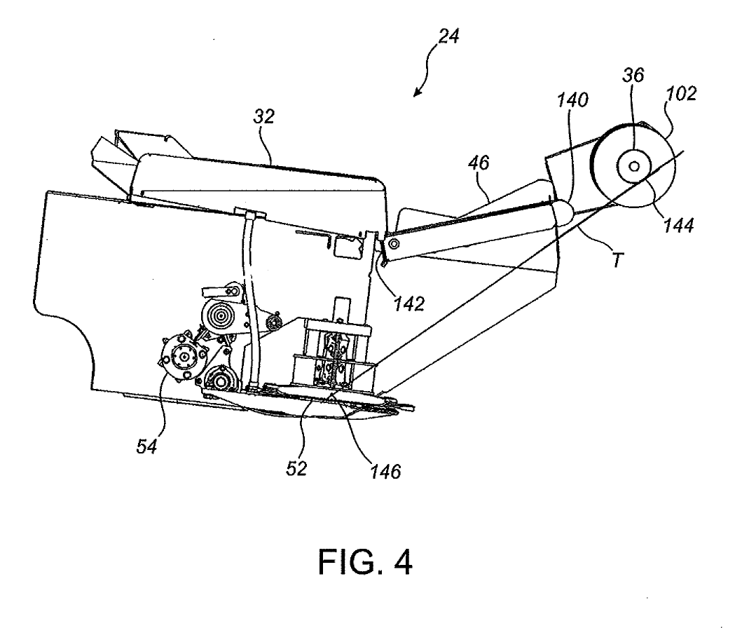

In the event tall robust crops are to be processed, the position of the cutter bar shield doors 46 are positioned to an elevated position as shown in FIGS. 2 and 4. As best seen in FIG. 4, the cutter bar shield doors 46 are elevated to a position such that the forward most point 140 of the cutter bar shield door 46 is higher (i.e., further from the surface of the ground) than the rearward most point 142 of the cutter bar shield door 46, and positioned behind the lean bar 36 such that the forward most point 140 of the cutter bar shield door 46 lies on or behind a tangent line T drawn between the forward edge 144 of the lean bar 36 and a rotational center 146 of the cutting elements 52. It is believed that positioning the cutter bar shield doors 46 in the elevated position improves crop flow of tall robust crops into the conditioner rolls 54 by reducing the tendency for the cut crop to be pinched between the standing crop 10 and the lower surfaces of the cutter bar shield doors 46. By elevating the cutter bar shield doors 46, a larger throat is provided to accommodate the large volumes to the pinch point of the conditioner rolls 54. Additionally, in an alternate embodiment, the header assembly 24 may be configured without a lean bar 36. In such embodiment, the forward most point 140 of the cutter bar shield door 46 acts to knock down crop material for processing by the header 32.

The foregoing has broadly outlined some of the more pertinent aspects and features of the present invention. These should be construed to be merely illustrative of some of the more prominent features and applications of the invention. Other beneficial results can be obtained by applying the disclosed information in a different manner or by modifying the disclosed embodiments. Accordingly, other aspects and a more comprehensive understanding of the invention may be obtained by referring to the detailed description of the exemplary embodiments taken in conjunction with the accompanying drawings, in addition to the scope of the invention defined by the claims.

What is claimed is:

1. A header assembly supported on the front of a windrower operable to process crop material standing in a field, the header assembly comprising:
a header configured to process the crop material, the header comprising a plurality of cutting elements arranged in a line transverse the header; and
a cutter bar shield door positioned to an elevated position such that a forward most point of the cutter bar shield door is forward of the line of cutting elements and wherein the forward most point of the cutter bar shield door is above a rearward most point of the cutter bar shield door.

2. The header assembly of claim 1 further comprising a lean bar positioned a distance forward of the header so that the lean bar is the forward-most element of the header assembly, wherein the forward most point of the cutter bar shield door lies on or behind a line drawn between a forward edge of the lean bar and a rotational center of one of the cutting elements.

3. A method of processing crop material in a field using a header assembly supported on the front of a windrower having a plurality of cutting elements in a line transverse the header used to cut standing crop material in the field, the method comprising:
positioning a cutter bar shield door to an elevated position such that a forward most point of the cutter bar shield door is above a rearward most point of the cutter bar shield door;
driving the header assembly through the field such that the crop material is bent by the header assembly and severed by the cutting elements before the crop material is pinched between the standing crop and a lower surfaces of the cutter bar shield door.

4. The method of claim 3 further comprising:
mounting a lean bar a distance forward of the header so that the lean bar is the forward-most element of the header assembly, and the forward most point of the cutter bar shield door lies on or behind a line drawn between the forward edge of the lean bar and a rotational center of the cutting elements; and
driving the header assembly through the field such that the crop material is bent by the lean bar and severed by the cutting elements before the crop material is pinched between the standing crop and a lower surfaces of the cutter bar shield door.
